(19) United States
(12) Patent Application Publication
(10) Pub. No.: US 2014/0101710 A1
(43) Pub. Date: Apr. 10, 2014

(54) CONTENT PROVIDING SCHEME

(71) Applicant: KT Corporation, Seongnam (KR)

(72) Inventors: Jong-heum KIM, Seongnam-si (KR); Yeong-joon JEONG, Seoul (KR); Sun-jong KWON, Seoul (KR); Gyu-tae BAEK, KR (KR)

(73) Assignee: KT Corporation, Seongnam (KR)

(21) Appl. No.: 14/050,528

(22) Filed: Oct. 10, 2013

(30) Foreign Application Priority Data
Oct. 10, 2012 (KR) 10-2012-0112632

(51) Int. Cl. H04N 21/61

(52) U.S. Cl. CPC H04N 21/6175
USPC 725/110

(57) ABSTRACT

In one example embodiment, a server includes a data receiving unit configured to receive metadata regarding television content; a data mapping unit configured to generate mapping information to associate web content with the television content based at least in part on the metadata; and an information transmitting unit configured to transmit the mapping information to an end device.

### TECHNICAL FIELD

The embodiments described herein pertain generally to schemes for providing web content and associated television content.

### BACKGROUND

An Internet Protocol Television (IPTV) system enables delivery of a digital television service to a viewer over a network infrastructure. The delivery is performed using Internet Protocols and typically includes a broadband connection. The IPTV system enables a viewer to select programs from a list, which is typically delivered over an IP network in the form of streaming video via a website.

### SUMMARY

In one example embodiment, a server includes a data receiving unit configured to receive metadata regarding television content; a data mapping unit configured to generate mapping information to associate web content with the television content based at least in part on the metadata; and an information transmitting unit configured to transmit the mapping information to an end device.

In another example embodiment, an end device includes a web content receiving unit configured to receive web content from a web content provider; a data receiving unit configured to receive mapping information to associate the web content with television content; a web content displaying unit configured to display the received web content and a television content selecting interface that is generated based at least in part on the mapping information; a television content selecting unit configured to receive a selection input from the television content selecting interface; and a television content receiving unit configured to: transmit a request for the television content to a television platform server based at least in part on the selection input, receive the requested television content from the television platform server, and display the received television content.

In yet another example embodiment, a method performed under control of a server includes transmitting web content to an end device; receiving, from a television platform server, metadata regarding television content; generating mapping information that associates the web content with the television content based at least in part on the metadata; and transmitting the mapping information to the end device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of a content providing scheme may be implemented;

FIG. 2 shows illustrative examples of metadata associated with one or more embodiments of a content providing scheme;

FIG. 3 shows illustrative examples of mapping information in accordance with one or more embodiments of a content providing scheme;

FIGS. 4A to 4C show illustrative examples of an end device in which one or more embodiments of a content providing scheme may be implemented;

FIG. 5 shows an example configuration of a web content provider by which at least portions of a content providing scheme may be implemented;

FIG. 6 shows an example configuration of an end device by which at least portions of a content providing scheme may be implemented;

FIG. 7 shows an example processing flow of operations for implementing at least portions of a content providing scheme;

FIG. 8 shows another example processing flow of operations for implementing at least portions of a content providing scheme;

FIG. 9 shows another example system configuration in which one or more embodiments of a content providing scheme may be implemented;

FIG. 10 shows yet other example processing flow of operations for implementing at least portions of a content providing scheme; and

FIG. 11 shows an illustrative computing embodiment, in which any of the processes and sub-processes of a content providing scheme may be implemented as computer-readable instructions stored on a computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

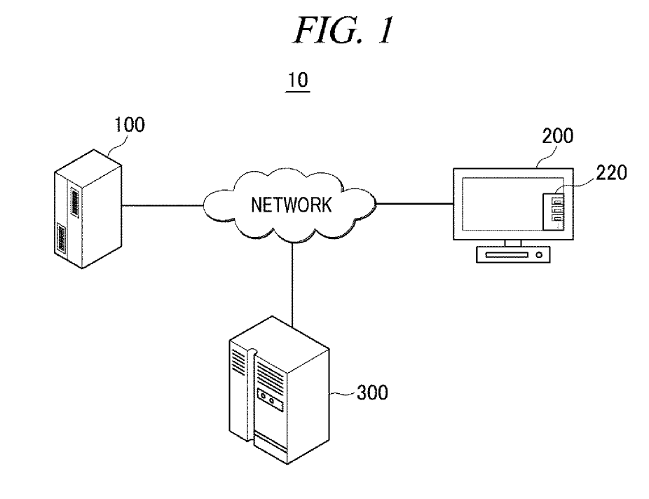

FIG. 1 shows an example system configuration in which one or more embodiments of a content providing scheme may be implemented. As depicted in FIG. 1, a system configuration 10 may include, at least, a web content provider 100, an end device 200 and a television platform server 300.

At least two or more of web content provider 100, end device 200 and television platform server 300 may be communicatively connected to each other via a network. By way of example, but not limitation, the network between web content provider 100, end device 200 and television platform server 300 may include a wired network such as LAN (Local Area Network), WAN (Wide Area Network), VAN (Value Added Network) or the like, or all kinds of wireless network such as a mobile radio communication network, a satellite network, Bluetooth, WiBro (Wireless Broadband Internet), Mobile WiMAX, HSDPA (High Speed Downlink Packet Access) or the like.

Web content provider 100 may refer to an organization or entity that provides some type of communications, data storage, data or information processing, content service, or any combination thereof for business customers or consumers who utilize end device 200. Web content provider 100 may host one or more servers or other processing apparatuses that may be configured to receive a request for web content and television content, and to transmit one web content and mapping information that associates the web content with television content to end device 200 in response to the received request. Non-limiting examples of web content provider 100 may include an Internet service provider, i.e., ISP; application service provider, i.e., ASP; storage service provider, i.e., SSP; and television service provider, i.e., cable TV, DSL and DBS.

End device 200 may refer to any type of a smart television, a set-top box and a display coupled to the set-top box, a notebook, a personal computer, a tablet computer, a phablet device, a smart phone, or a personal communication terminal, which are capable of displaying web content and television content.

Television platform server 300 may refer to one or more servers or other processing apparatuses that may be configured to receive a request for television content, and to transmit the requested television content to end device 200.

In some embodiments, end device 200 may be configured to transmit a request for web content to web content provider 100. By way of example, but not limitation, the requested web content may include a web site, which includes multiple html or javascript components; or video or audio content, which may be displayed or played via a web browser hosted by end device 200. By way of further example, the web content may include a web site or content that may be displayed by internet protocol television (IPTV).

Web content provider 100 may be configured to authenticate end device 200, from which the request for the web content was sent, based at least in part on authenticating information corresponding to end device 200. End device 200 may be configured to transmit the authenticating information corresponding to end device 200 to web content provider 100 together with the web content request. By way of example, but not limitation, the authenticating information may include at least one of a unique identifier of end device 200, a media access control (MAC) address of end device 200, an internet protocol (IP) address of end device 200, a serial number assigned to end device 200, a telephone number assigned to end device 200, and/or biometric information corresponding to a user of end device 200, such as a fingerprint, a facial image, or a pupil image of the user. Web content provider 100 may be configured to previously store and/or register information or data regarding the authenticating information corresponding to end device 200, and authenticate end device 200 based on the previously stored information and the transmitted authenticating information.

Web content provider 100 may be further configured to transmit the web content to end device 200 in response to the web content request. End device 200 may be configured to receive the web content, and display the received web content via a web browser.

Further, web content provider 100 may be configured to receive, from television platform server 300, metadata regarding at least the requested television content. By way of example, but not limitation, the metadata may include information pertaining to the requested television content, including, but not limited to: a title, a play time, a genre, a display resolution, a director, an actor or actress; or a uniform resource locator (URL) or a hyper-link to television platform server 300 to display the requested television content.

In some embodiments, web content provider 100 may be configured to transmit, to television platform server 300, a request for the metadata regarding the requested television content, which is associated with the web content transmitted to end device 200, when web content provider 100 receives the web content request. By way of example, web content provider 100 may be configured to send web content information to television platform server 300. Non-limiting examples of the web content information may include a web content identifier for the web content. Television platform server 300 may be further configured to transmit the metadata associated with the web content information to web content provider 100. By way of example, but not limitation, web content provider 100 may be configured to receive the metadata from television platform server 300 upon calling an application programming interface (API) function.

In some other embodiments, web content provider 100 may be configured to receive metadata that includes multiple sub-metadata regarding television content from television platform server 300. By way of example, but not limitation, web content provider 100 may be configured to receive the metadata generated by television platform server 300, from a file transfer protocol (FTP) server that is communicatively coupled to web content provider 100 and television platform server 300. Then, web content provider 100 may be configured to select at least some of the sub-metadata that is associated with the web content transmitted to end device 200, from among the multiple sub-metadata based at least in part on web content information such as a title, genre, actor/actress, etc.

Web content provider 100 may be configured to generate mapping information to associate the web content, which is transmitted to end device 200, and the television content, which is associated with the web content based at least in part on the received metadata. By way of example, but not limitation, the mapping information may include web content information, such as a web content ID; television content information, such as a television content ID; and a URL corresponding to television platform server 300 to display the television content.

Further, web content provider 100 may be configured to provide end device 200 with a television content selecting interface 220. For example, television content selecting interface 220 may refer to an icon or a small sized display, which represents television content associated with the web content that is transmitted to end device 200. End device 200 may be configured to receive a selection input from television content selecting interface 220. Then, end device 200 may be configured to transmit, to web content provider 100, a request for television content information regarding the television content associated with the web content and the selected television content selecting interface.

Web content provider 100 may be configured to transmit the mapping information regarding the selected television content and the web content which is associated with the selected television content to end device 200 in response to the request for the television content information. Then, end device 200 may be configured to receive the mapping information from web content provider 100.

End device 200 may be further configured to transmit a request for the television content to television platform server 300, based at least in part on the received mapping information. By way of example, but not limitation, end device 200 may call the URL of television platform server 300, which is included in the mapping information, in order to request the television content. Television platform server 300 may be configured to then transmit the requested television content to end device 200. End device 200 may be configured to receive the television content from television platform server 300, and display the received television content on a display which is operatively coupled to end device 200.

Thus, FIG. 1 shows example system configuration 10 in which one or more embodiments of content providing scheme may be implemented.

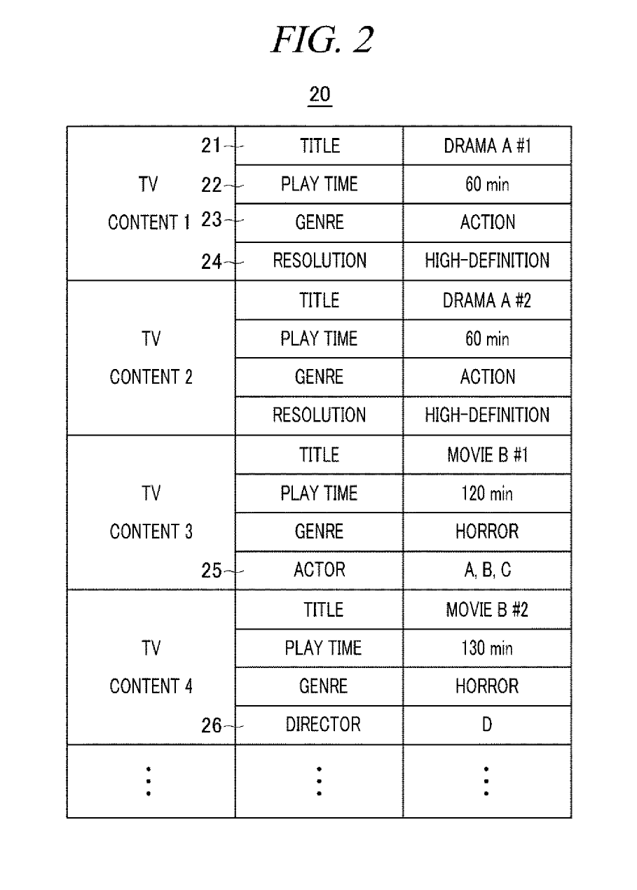

FIG. 2 shows illustrative examples of metadata associated with one or more embodiments of a content providing scheme. Television platform server 300 may be configured to transmit metadata 20 regarding some television content to web content provider 100. In some embodiments, television platform server 300 may be configured to generate and store a kind of metadata table or metadata database including metadata 20. By way of example, but not limitation, as depicted in FIG. 2, metadata 20 of each television content may include information regarding a title 21, a play time 22, a genre 23, a display resolution 23, an actor/actress 25, a director 26 of the each television content. However, the kinds of included in metadata 20 may be changed according to the television content.

Thus, FIG. 2 shows illustrative examples of metadata 20 of one or more embodiments of a content providing scheme.

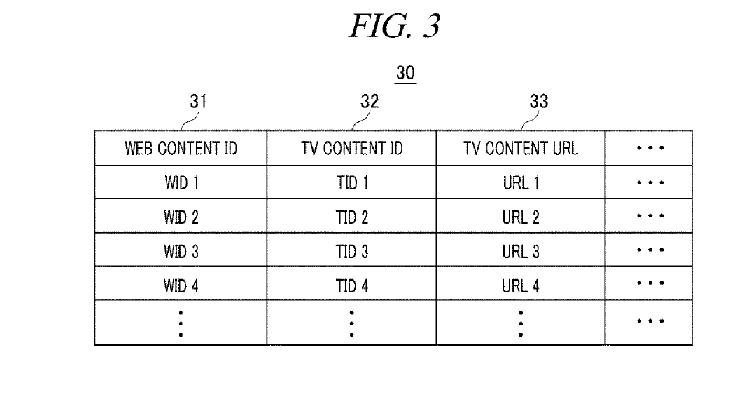

FIG. 3 shows illustrative examples of mapping information in accordance with one or more embodiments of a content providing scheme. Web content provider 100 may be configured to receive metadata from television platform server 300 and then generate mapping information 30 to associate web content with television content. In some embodiments, web content provider 100 may be configured to generate and store a kind of mapping information table or mapping information database including mapping information 30. By way of example, but not limitation, as depicted in FIG. 3, mapping information 30 may include at least a web content ID field 31, a television content ID field 32 and a television content URL field 33. Mapping information 30 may associate a web content ID, a television content ID and a television content URL, which is designated to television platform server 300 and called to receive television content.

Thus, FIG. 3 shows illustrative examples of mapping information 30 in accordance with one or more embodiments of content providing scheme.

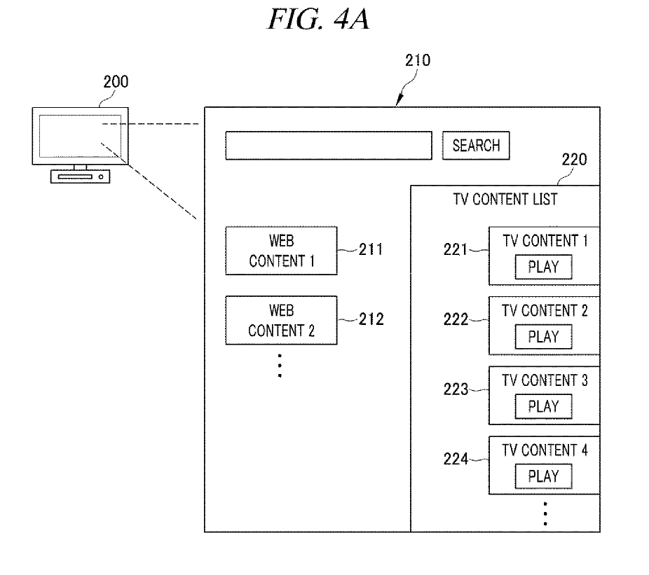

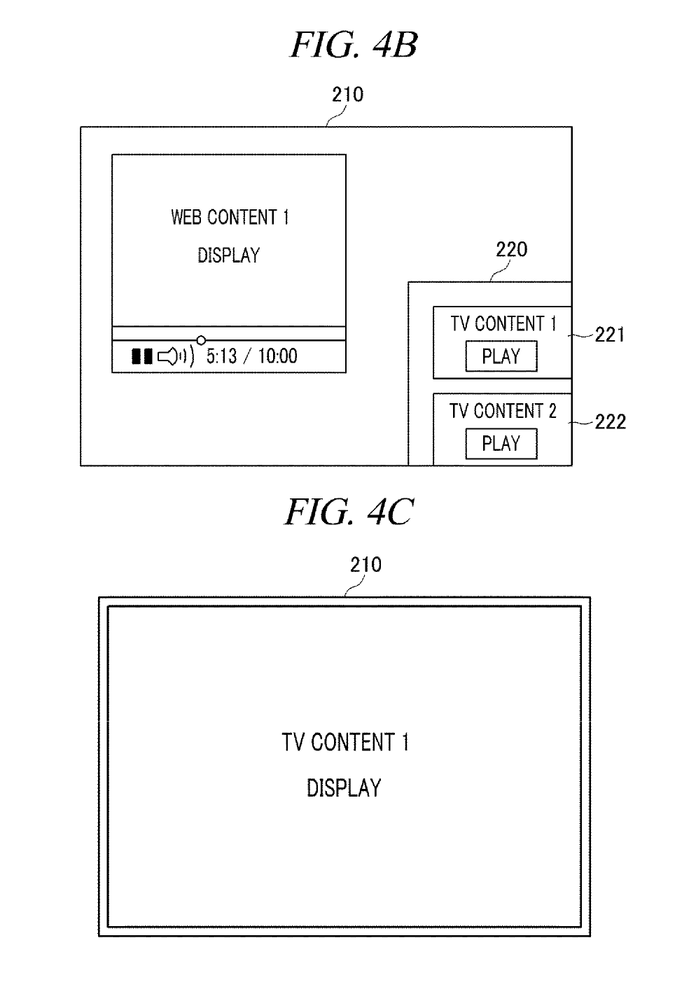

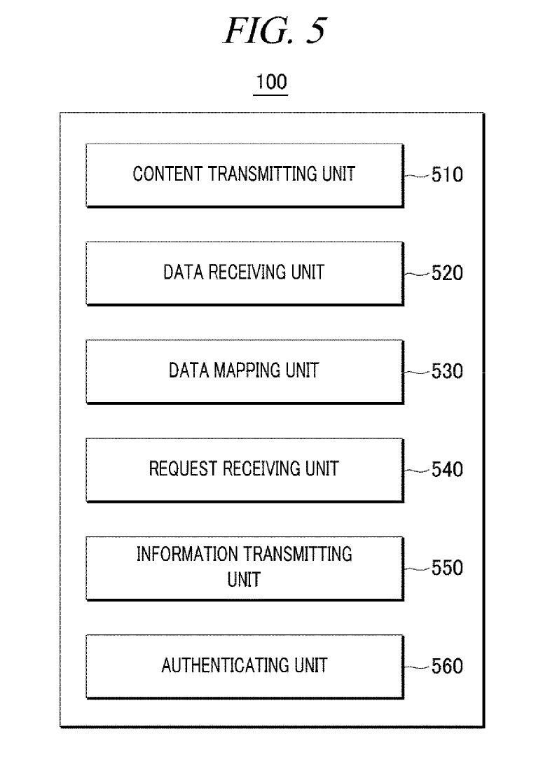

FIGS. 4A to 4C show illustrative examples of end device 200 in which one or more embodiments of a content providing scheme may be implemented.

In some embodiments, a web page or web site may be provided to end device 200 by web content provider 100 and displayed on a display 210 that is operatively coupled to end device 200 based on mapping information to associate web content and television content. By way of example, but not limitation, as depicted in FIG. 4A, the web page may include multiple web content selecting interfaces 211 and 212 and multiple television content selecting interfaces 221, 222, 223 and 224.

As referenced herein, web content selecting interface 211 and 212 may each refer to an icon or a small sized display that is associated with web content. Television content selecting interface 221, 222, 223, and 224 may each refer to an icon or a small sized display that is associated with television content. It should be noted that the embodiments described herein are examples only. Thus, the content providing schemes described herein are in no way limited to two web content selecting interfaces and/or four television content selecting interfaces.

By way of example, web content selecting interface 211 may be associated with web content No. 1, and web content selecting interface 212 may be associated with web content No. 2. Further, television content selecting interface 221 may be associated with television content No. 1, which is associated with at least one of web content No. 1 or web content No. 2. Television content selecting interface 222 may be associated with television content No. 2, which is associated with at least one of web content No. 1 or web content No. 2. Television content selecting interface 223 may be associated with television content No. 3, which is associated with at least one of web content No. 1 or web content No. 2. Television content selecting interface 224 may be associated with television content No. 4, which is associated with at least one of web content No. 1 or web content No. 2.

As depicted in FIG. 4B, end device 200 may be configured to transmit a request for web content No. 1 to web content provider 100 when end device 200 receives a selection input via web content selecting interface 211. Web content No. 1 may be associated with web content selecting interface 211. Web content provider 100 may be configured to transmit the requested web content No. 1 to end device 200, and end device 200 may be configured to display the received web content No. 1 on display 210. By way of example, the web content ultimately received by end device 200 may include a partial video of the television content. By way of further example, the received web content may refer to content of which an image resolution is lower than an image resolution of corresponding television content.

Further, if end device 200 receives the selection input via web content selecting interface 211, television content selecting interfaces 211 and 212 associated with television content No. 1 and No. 2, respectively, which are associated with the selected web content No. 1, may be displayed on display 210 of end device 200.

As depicted in FIG. 4C, end device 200 may be configured to transmit a request for television content information regarding the television content No. 1 associated with web content No. 1 to web content provider 100 when end device 200 receives a selection input via television content selecting interface 221. Web content provider 100 may be configured to transmit, to end device 200, mapping information regarding the request television content No. 1 and the web content No. 1, and end device 200 may be configured to receive the mapping information.

Further, end device 200 may be configured to transmit a request for the television content No. 1 to television platform server 300, based at least in part on the selection input and the received mapping information. By way of example, but not limitation, end device 200 may call a URL of television platform server 300, which may be included in the mapping information, for requesting the television content No. 1. Television platform server 300 may be configured to transmit the television content No. 1 to end device 200 in response to the request. End device 200 may be configured to receive the television content No. 1 from television platform server 300 and display the received television content No. 1 on display 210.

Thus, FIGS. 4A to 4C show illustrative examples of end device 200 in which one or more embodiments of a content providing scheme may be implemented.

FIG. 5 shows an example configuration of web content provider 100 by which at least portions of a content providing scheme may be implemented. As depicted in FIG. 5, web content provider 100 may include a content transmitting unit 510, a data receiving unit 520, a data mapping unit 530, a request receiving unit 540, an information transmitting unit 550 and an authenticating unit 560. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of content transmitting unit 510, data receiving unit 520, data mapping unit 530, request receiving unit 540, information transmitting unit 550 and authenticating unit 560 may be included in an instance of an application hosted on web content provider 100.

Content transmitting unit 510 may be configured to transmit web content to end device 200, via a network. In some embodiments, content transmitting unit 510 may be configured to transmit, to end device 200, the web content that is requested by end device 200 in response to a web content request. Further, content transmitting unit 510 may be configured to provide end device 200 with at least one of television content selecting interfaces 221-224 and at least one of web content selecting interfaces 211 and 212. By way of example, but not limitation, the television content selecting interfaces may each refer to an icon or a small sized display, which represents television content associated with the web content that is transmitted to end device 200. Further, the web content selecting interfaces may each refer to an icon or a small sized display that represents the web content transmitted to end device 200.

Data receiving unit 520 may be configured to receive metadata regarding television content from television platform server 300. In some embodiments, when request receiving unit 540 receives a request for web content, data receiving unit 520 may be configured to transmit, to television platform server 300, a request for metadata regarding television content that is associated with the requested web content. By way of example, data receiving unit 520 may transmit, to television platform server 300, a request that includes web content information such as a web content identifier (ID). Data receiving unit 520 may be configured to then receive the metadata that is associated with the web content information from television platform server 300. By way of example, but not limitation, data receiving unit 520 may be configured to receive the metadata from television platform server 300 upon calling an application programming interface (API) function.

In some embodiments, data receiving unit 520 may be configured to receive metadata that includes multiple sub-metadata regarding television content from television platform server 300. By way of example, but not limitation, data receiving unit 520 may be configured to receive the metadata generated by television platform server 300, from a file transfer protocol (FTP) server, which is operatively coupled to web content provider 100 and television platform server 300. Data receiving unit 520 may be configured to then select at least some of the sub-metadata that are associated with the web content transmitted to end device 200, from among the multiple sub-metadata based on web content information, such as title, genre, actor/actress, etc.

Data mapping unit 530 may be configured to generate mapping information to associate the web content, which is transmitted to end device 200, with the television content, based at least in part on the received metadata. By way of example, but not limitation, the mapping information may include web content information, such as a web content ID; television content information, such as a television content ID; and a URL of television platform server 300 for receiving the television content.

Request receiving unit 540 may be configured to receive a request for web content from end device 200. Further, request receiving unit 540 may be configured to receive a request for television content information regarding the television content which is associated with the web content transmitted to end device 200, when end device 200 receives a selection input on a television content selecting interface associated with the television content.

Information transmitting unit 550 may be configured to transmit the mapping information regarding the selected television content and the web content that is associated with the selected television content to end device 200 in response to the request for the television content information.

Authenticating unit 560 may be configured to authenticate end device 200, which requested at least one of the web content or the television content information, based at least in part on authenticating information corresponding to end device 200. Authenticating unit 560 may be configured to receive the authenticating information corresponding to end device 200 from end device 200. By way of example, but not limitation, the authenticating information may include at least one of a unique identifier of end device 200, a MAC address of end device 200, an IP address of end device 200, a serial number assigned to end device 200, a telephone number assigned end device 200, biometric information of a user of end device 200, such as a finger print of the user.

Thus, FIG. 5 shows an example configuration of web content provider 100 by which at least portions of a content providing scheme may be implemented.

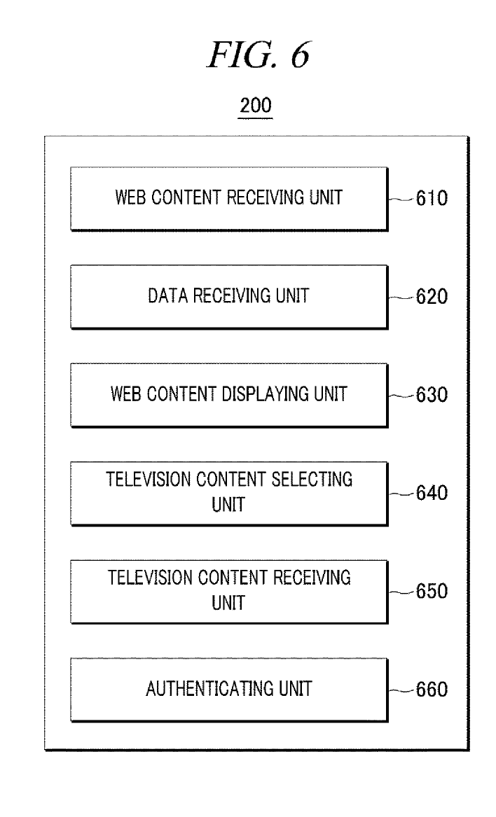

FIG. 6 shows an example configuration of end device 200 by which at least portions of a content providing scheme may be implemented. As depicted in FIG. 6, end device 200 may include a web content receiving unit 610, a data receiving unit 620, a web content displaying unit 630, a television content selecting unit 640, a television content receiving unit 650 and an authenticating unit 660. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of web content receiving unit 610, data receiving unit 620, web content displaying unit 630, television content selecting unit 640, television content receiving unit 650 and authenticating unit 660 may be included in an instance of an application hosted on end device 200.

Web content receiving unit 610 may be configured to receive web content from web content provider 100. By way of example, but not limitation, the web content may include a web site, which includes multiple html or javascript components, or video or audio content, which may be displayed via a web browser hosted by end device 200. Further, the web content may include a web site or content that may be displayed by internet protocol television (IPTV). Further, web content receiving unit 610 may be configured to receive, from web content provider 100, at least one web content selecting interface and at least one television content selecting interface that are generated based at least in part on mapping information stored in web content provider 100.

Data receiving unit 620 may be configured to receive mapping information that associates the received web content and associated television content.

Web content displaying unit 630 may be configured to display the web content received by web content receiving unit 610. Further, web content displaying unit 630 may be configured to display the at least one web content selecting interface and at least one television content selecting interface. By way of example, web content displaying unit 630 may include a web browser.

Television content selecting unit 640 may be configured to receive a selection input from the at least one television content selecting interface.

Television content receiving unit 650 may be configured to transmit, to web content provider 100, a request for television content information that is associated with television content associated with the selected television content selecting interface. Data receiving unit 620 may be configured to then receive mapping information from web content provider 100 in response to the request for the television content information.

Further, television content receiving unit 650 may be configured to transmit a request for television content associated with the selected television content selecting interface to television platform server 300 based at least in part on the mapping information. By way of example, but not limitation, television content receiving unit 650 may call a URL of television platform server 300, which is included in the mapping information. Television content receiving unit 650 may be configured to then receive the requested television content from television platform server 300 and to display the received television content on a display that is operatively coupled to end device 200.

Authenticating unit 660 may be configured to transmit authenticating information corresponding to end device 200 to web content provider 100. By way of example, but not limitation, the authenticating information may include at least one of a unique identifier of end device 200, a MAC address of end device 200, an IP address of end device 200, a serial number assigned to end device 200, a telephone number assigned to end device 200 and/or biometric information of a user of end device 200, such as a finger print of the user.

Thus, FIG. 6 shows an example configuration of end device 200 by which at least portions of a content providing scheme may be implemented.

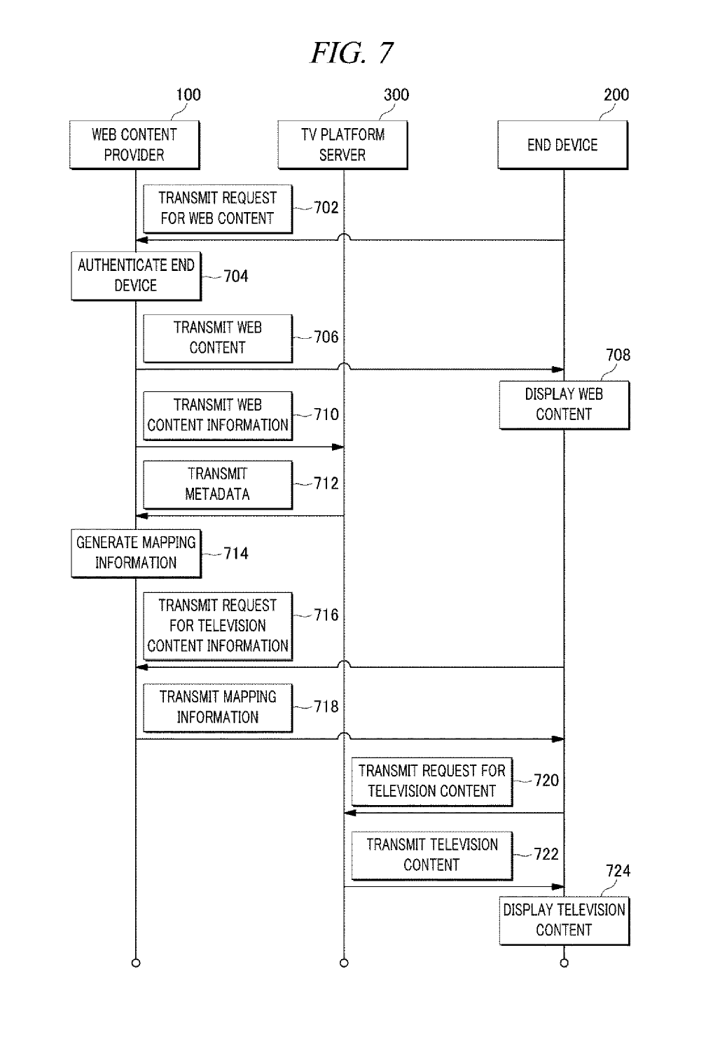

FIG. 7 shows an example processing flow of operations for implementing at least portions of a content providing scheme. The operations in FIG. 7 may be implemented in system configuration 10 including web content provider 100, end device 200 and television platform server 300, as illustrated in FIG. 1. An example process may include one or more operations, actions, or functions as illustrated by one or more blocks 702, 704, 706, 708, 710, 712, 714, 716, 718, 720, 722 and/or 724. Although illustrated as discrete blocks, various blocks may be divided into additional blocks, combined into fewer blocks, or eliminated, depending on the desired implementation. Processing may begin at block 702.

Block 702 (Transmit Request for Web Content) may refer to end device 200 transmitting a request for web content to web content provider 100. In some embodiments, end device 200 may receive a selection input from at least one web content selecting interface, and transmit a request for web content that is associated with the selected web content selecting interface to web content provider 100. Further, at block 702, end device 200 may transmit authenticating information of end device 200 to web content provider 100. Processing may proceed from block 702 to block 704.

Block 704 (Authenticate End Device) may refer to web content provider 100 authenticating end device 200. In some embodiments, web content provider 100 may pre-register authenticating information of end device 200 in a memory. Further, web content provider 100 may compare the pre-registered authenticating information and the received authenticating information. If the received authenticating information is the same as the pre-registered authenticating information, web content provider 100 may authenticate end device 200. Processing may proceed from block 704 to block 706.

Block 706 (Transmit Web Content) may refer to web content provider 100 transmitting, to end device 200, the web content that is requested by end device 200 at block 702 in response to the web content request. Processing may proceed from block 706 to block 708.

Block 708 (Display Web Content) may refer to end device 200 receiving the web content from web content provider 100 and displaying the received web content via a web browser. Processing may proceed from block 708 to block 710.

Block 710 (Transmit Web Content Information) may refer to web content provider 100 transmitting, to television platform server 300, web content information regarding the web content that is transmitted to end device 200 at block 706. By way of example, the web content information may include a web content identifier. Processing may proceed from block 710 to block 712.

Block 712 (Transmit Metadata) may refer to television platform server 300 transmitting, to web content provider 100, metadata that is associated with the web content information and television content associated with the web content transmitted, to end device 200. Further, web content provider 100 may receive the metadata by calling an application programming interface (API) function. Processing may proceed from block 712 to block 714.

Block 714 (Generate Mapping Information) may refer to web content provider 100 generating mapping information that associates the web content with the television content based at least in part on the metadata received at block 712. Processing may proceed from block 714 to block 716.

Block 716 (Transmit Request for Television Content Information) may refer to end device 200 transmitting, to web content provider 100, a request for television content information regarding the television content that is associated with the web content, which is transmitted to end device 200 at block 706. Processing may proceed from block 716 to block 718.

Block 718 (Transmit Mapping Information) may refer to web content provider 100 transmitting, to end device 200, the mapping information generated at block 714 in response to the request for the television content information. Processing may proceed from block 718 to block 720.

Block 720 (Transmit Request for Television Content) may refer to end device 200 transmitting a request for the television content. In some embodiments, at block 720, end device 200 may receive a selection input on a television content selecting interface, which is associated with the television content and is displayed on a web browser of end device 200. Further, end device 200 may transmit, to television platform server 300, a request for the television content based at least in part on the selection input and the mapping information received at block 718. By way of example, at block 720, end device 200 may call a URL of television platform server 300, which is included in the mapping information in order to receive the television content. Processing may proceed from block 720 to block 722.

Block 722 (Transmit Television Content) may refer to television platform server 300 transmitting the television content, which is requested at block 720, to end device 200. Processing may proceed from block 722 to block 724.

Block 724 (Display Television Content) may refer to end device 200 displaying the television content received at block 722.

Thus, FIG. 7 shows an example processing flow of operations for implementing at least portions of a content providing scheme.

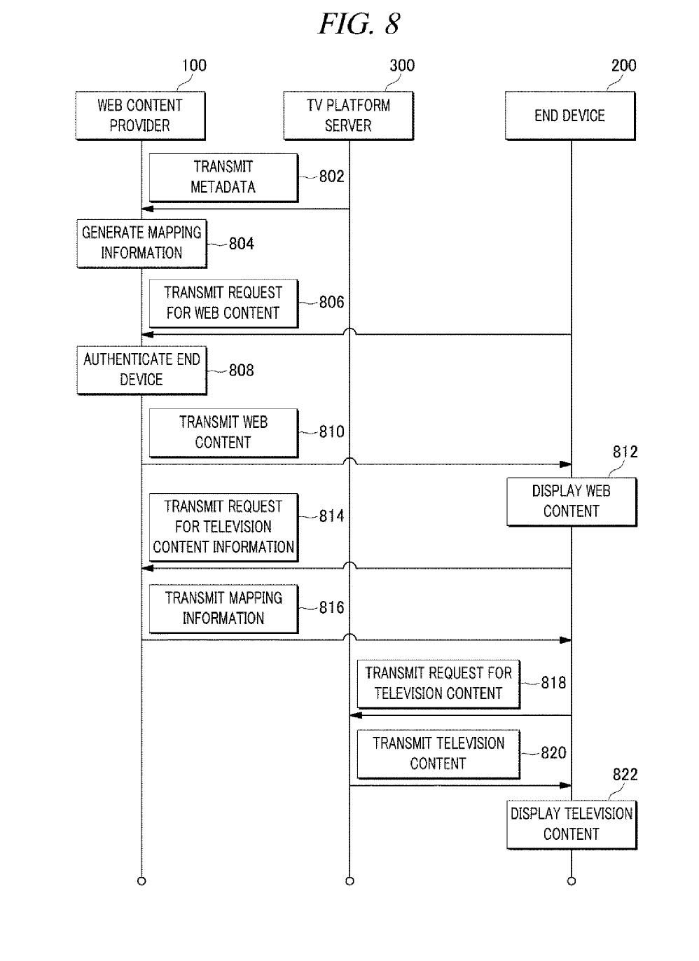

FIG. 8 shows another example processing flow of operations for implementing at least portions of a content providing scheme. The operations in FIG. 8 may be implemented in system configuration 10 including web content provider 100, end device 200 and television platform server 300, as illustrated in FIG. 1. An example process may include one or more operations, actions, or functions as illustrated by one or more blocks 802, 804, 806, 808, 810, 812, 814, 816, 818, 820 and/or 822. Although illustrated as discrete blocks, various blocks may be divided into additional blocks, combined into fewer blocks, or eliminated, depending on the desired implementation. Processing may begin at block 802.

Block 802 (Transmit Metadata) may refer to television platform server 300 transmitting metadata regarding television content. At block 802, television platform server 300 may transmit, to web content provider 100, metadata that includes sub-metadata that are associated with television content. Processing may proceed from block 802 to block 804.

Block 804 (Generate Mapping Information) may refer to web content provider 100 generating mapping information that associates web content with corresponding television content. In some embodiments, web content provider 100 may select sub-metadata regarding television content that is associated with web content. Then, web content provider 100 may associate the selected television content with the web content based at least in part on the selected sub-metadata. Processing may proceed from block 804 to block 806.

Block 806 (Transmit Request for Web Content) may refer to end device 200 transmitting a request for web content to web content provider 100. Further, at block 806, end device 200 may transmit authenticating information of end device 200 to web content provider 100. Processing may proceed from block 806 to block 808.

Block 808 (Authenticate End Device) may refer to web content provider 100 authenticating end device 200 based at least in part on the authenticating information of end device 200, which is received at block 806. Processing may proceed from block 808 to block 810.

Block 810 (Transmit Web Content) may refer to web content provider 100 transmitting, to end device 200, the web content that is requested by end device 200 at block 806, in response to the web content request. Processing may proceed from block 810 to block 812.

Block 812 (Display Web Content) may refer to end device 200 receiving the web content from web content provider 100 and displaying the received web content via a web browser. Processing may proceed from block 812 to block 814.

Block 814 (Transmit Request for Television Content Information) may refer to end device 200 transmitting, to web content provider 100, a request for television content information regarding television content that is associated with the web content that is transmitted to end device 200 at block 810. Processing may proceed from block 814 to block 816.

Block 816 (Transmit Mapping Information) may refer to web content provider 100 transmitting, to end device 200, the mapping information generated at block 804, in response to the request for the television content information. Web content provider 100 may transmit, to end device 200, the mapping information that associates the television content that is requested at block 814 with the web content that is displayed at block 812. Processing may proceed from block 816 to block 818.

Block 818 (Transmit Request for Television Content) may refer to end device 200 transmitting, to television platform server 300, a request for the television content based at least in part on the mapping information received at block 816. By way of example, at block 818, end device 200 may call a URL of television platform server 300, which is included in the mapping information in order to receive the television content. Processing may proceed from block 818 to block 820.

Block 820 (Transmit Television Content) may refer to television platform server 300 transmitting the television content that is requested at block 818 to end device 200. Processing may proceed from block 820 to block 822.

Block 822 (Display Television Content) may refer to end device 200 displaying the television content received at block 820.

Thus, FIG. 8 shows another example processing flow of operations for implementing at least portions of a content providing scheme.

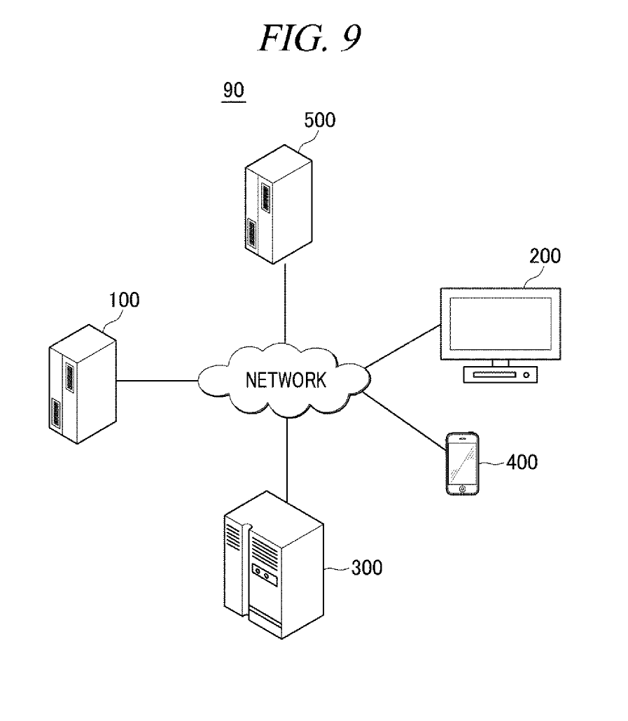

FIG. 9 shows another example system configuration in which one or more embodiments of a content providing scheme may be implemented. As depicted in FIG. 9, a system configuration 90 may include, at least, web content provider 100, end device 200, television platform server 300, a mobile device 400 and a control server 500. At least two of web content provider 100, end device 200, television platform server 300, mobile device 400 and control server 500 may be communicatively coupled to each other via a network.

In some embodiments, mobile device 400 may be affiliated with end device 200. By way of example, mobile device 400 and end device 200 may be registered in or logged in web content provider 100, television platform server 300 or any other content service provider that provides content providing service by using a same log-in identifier. Further, the quantity of embodiments of mobile device 400 communicatively coupled to end device 200 may vary from one implementation of a content providing scheme to another. In some embodiments, mobile device 400 may refer to a device that may be unable to display television content. Regardless, mobile device 400 may refer to at least one of a mobile phone, a notebook, a table computer, a hybrid phone/tablet device, a portable computing/communication device, or a personal communication terminal, such as PCS (Personal Communication System), GMS (Global System for Mobile communications), PDC (Personal Digital Cellular), PDA (Personal Digital Assistant). The device may even be a CDMA (Code Division Multiple Access)-2000, W-CDMA (W-Code Division Multiple Access), or Wibro (Wireless Broadband Internet) terminal.

Control server 500 may refer to an apparatus or a server that may be configured to control a communication connection between end device 200 and mobile device 400. In some embodiments, control server 500 may store and/or provide information regarding the communication connection between end device 200 and mobile device 400, which includes at least one of identification information, log-in information, Internet Protocol addresses, or port numbers of end device 200 and mobile device 400. By way of example, control server 500 may provide an N-scree service that makes it possible for multiple devices to display at least some content continuously.

In some embodiments, mobile device 400 may be configured to transmit a request for at least some web content to web content provider 100. Then, web content provider 100 may be configured to transmit the requested web content to mobile device 400. Mobile device 400 may be configured to receive the web content and to display the received web content via a web browser.

Further, mobile device 400 may be configured to transmit, to web content provider 100, a request for television content information regarding television content that is associated with the web content. By way of example, but not limitation, mobile device 400 may be configured to receive a selecting input from at least one television content selecting interface. Mobile device 400 may be further configured to transmit, to web content provider 100, a request for television content information regarding television content, which is associated with the selected television content selecting interface.

Then, web content provider 100 may be configured to transmit, to mobile device 400, mapping information that associates the television content with the web content, which is transmitted to mobile device 400, in response to the request for the television content information.

Further, mobile device 400 may be configured to receive the mapping information from web content provider 100, and transmit the received mapping information to control server 500. Control server 500 may be configured to receive the mapping information from mobile device 400, and transmit the received mapping information to end device 200 based at least in part on the connection information between end device 200 and mobile device 400.

End device 200 may be configured to transmit, to web content provider 100, a request for the television content that is selected by mobile device 400 based at least in part on the mapping information. By way of example, but not limitation, end device 200 may call a URL of television platform server 300, which is included in the mapping information. End device 200 may be configured to then receive the requested television content from television platform server 300, and display the received television content on a display which is operatively coupled to end device 200.

Thus, FIG. 9 shows another example system configuration 90 in which one or more embodiments of a content providing scheme may be implemented.

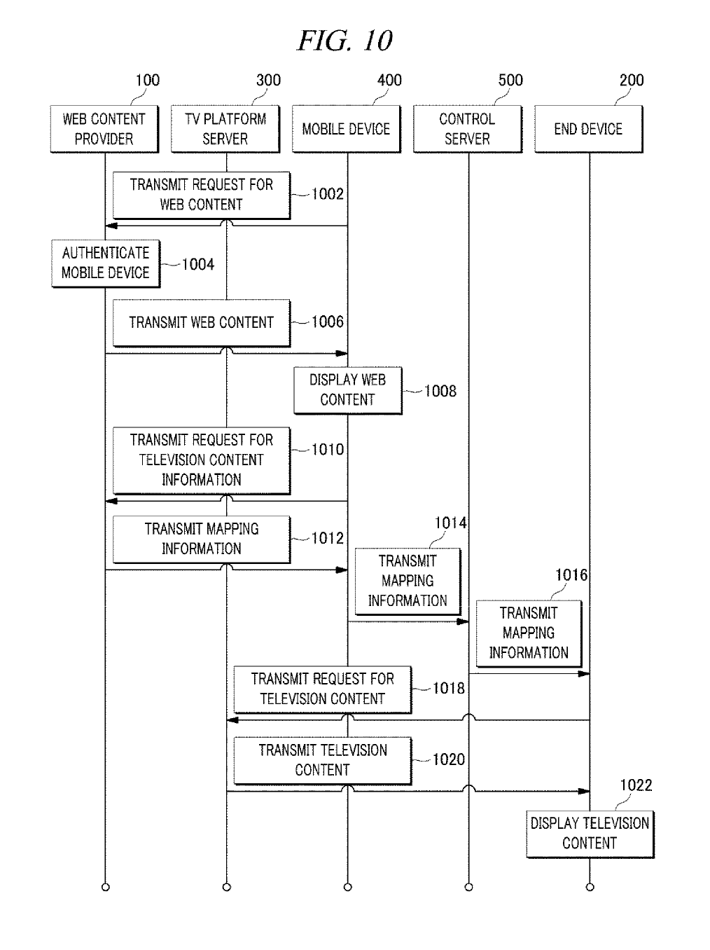

FIG. 10 shows yet other example processing flow of operations for implementing at least portions of a content providing scheme. The operations in FIG. 10 may be implemented in system configuration 90 including web content provider 100, end device 200, television platform server 300, mobile device 400 and control server 500, as illustrated in FIG. 9. An example process may include one or more operations, actions, or functions as illustrated by one or more blocks 1002, 1004, 1006, 1008, 1010, 1012, 1014, 1016, 1018, 1020 and/or 1022. Although illustrated as discrete blocks, various blocks may be divided into additional blocks, combined into fewer blocks, or eliminated, depending on the desired implementation. Processing may begin at block 1002.

Block 1002 (Transmit Request for Web Content) may refer to mobile device 400 transmitting a request for web content to web content provider 100. In some embodiments, mobile device 400 may receive a selection input from at least one web content selecting interface, and transmit, to web content provider 100, a request for web content that is associated with the selected web content selecting interface. Further, at block 1002, mobile device 400 may transmit authenticating information of mobile device 400 to web content provider 100. Processing may proceed from block 1002 to block 1004.

Block 1004 (Authenticate Mobile Device) may refer to web content provider 100 authenticating mobile device 400 based at least in part on the authenticating information of mobile device 400. Processing may proceed from block 1004 to block 1006.

Block 1006 (Transmit Web Content) may refer to web content provider 100 transmitting, to mobile device 400, the web content that is requested by mobile device 400 at block 1002, in response to the web content request. Processing may proceed from block 1006 to block 1008.

Block 1008 (Display Web Content) may refer to mobile device 400 receiving the web content from web content provider 100, and displaying the received web content via a web browser. Processing may proceed from block 1008 to block 1010.

Block 1010 (Transmit Request for Television Content Information) may refer to mobile device 400 transmitting, to web content provider 100, a request for television content information regarding television content that is associated with the web content, which is transmitted to mobile device 400 at block 1006. In some embodiments, at block 1010, mobile device 400 may receive a selection input on a television content selecting interface that is associated with the television content and is displayed on a web browser of mobile device 400. Then, mobile device 400 may transmit, to web content provider 100, the request for the television content information regarding the television content which is associated with the selected television content selecting interface. Processing may proceed from block 1010 to block 1012.

Block 1012 (Transmit Mapping Information) may refer to web content provider 100 transmitting mapping information, to mobile device 400, mapping information that associates the television content, which is requested at block 1012, with the web content, which is displayed at block 1008, in response to the request for the television content information. Processing may proceed from block 1012 to block 1014.

Block 1014 (Transmit Mapping Information) may refer to mobile device 400 transmitting the received mapping information to control server 500. Processing may proceed from block 1014 to block 1016.

Block 1016 (Transmit Mapping Information) may refer to control server 500 transmitting the received mapping information received at block 1014 to end device 200 based at least in part on connection information between end device 200 and mobile device 400, which includes at least one of identification information, internet protocol addresses, or port numbers of end device 200 and mobile device 400. Processing may proceed from block 1016 to block 1018.

Block 1018 (Transmit Request for Television Content) may refer to end device 200 transmitting, to television platform server 300, a request for the television content based at least in part on the mapping information received at block 1016. By way of example, but not limitation, at block 1018, end device 200 may call a URL of television platform server 300, which is included in the mapping information in order to receive the television content. Processing may proceed from block 1018 to block 1020.

Block 1020 (Transmit Television Content) may refer to television platform server 300 transmitting the television content, which is requested at block 1018, to end device 200. Processing may proceed from block 1020 to block 1022.

Block 1022 (Display Television Content) may refer to end device 200 displaying the television content received at block 1020.

Thus, FIG. 10 shows yet other example processing flow of operations for implementing at least portions of content providing scheme.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

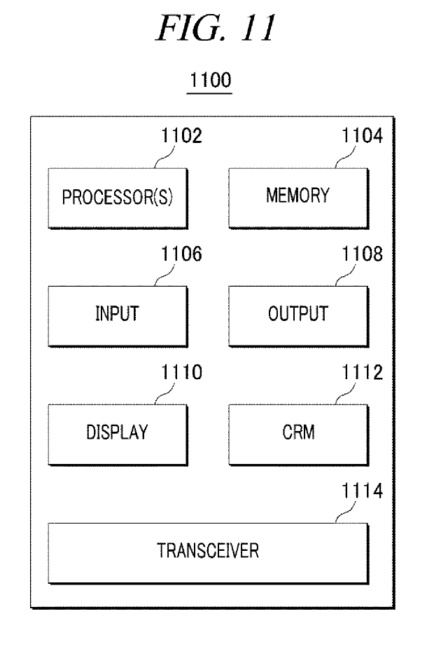

FIG. 11 shows an illustrative computing embodiment, in which any of the processes and sub-processes of a content providing scheme may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 10 or 90 for transactional permissions.

In a very basic configuration, a computing device 1100 may typically include, at least, one or more processors 1102, a system memory 1104, one or more input components 1106, one or more output components 1108, a display component 1110, a computer-readable medium 1112, and a transceiver 1114.

Processor 1102 may refer to, e.g., a microprocessor, a microcontroller, a digital signal processor, or any combination thereof.

Memory 1104 may refer to, e.g., a volatile memory, non-volatile memory, or any combination thereof. Memory 1104 may store, therein, an operating system, an application, and/or program data. That is, memory 1104 may store executable instructions to implement any of the functions or operations described above and, therefore, memory 1104 may be regarded as a computer-readable medium.

Input component 1106 may refer to a built-in or communicatively coupled keyboard, touch screen, or telecommunication device. Alternatively, input component 1106 may include a microphone that is configured, in cooperation with a voice-recognition program that may be stored in memory 1104, to receive voice commands from a user of computing device 1100. Further, input component 1106, if not built-in to computing device 1100, may be communicatively coupled thereto via short-range communication protocols including, but not limitation, radio frequency or Bluetooth.

Output component 1108 may refer to a component or module, built-in or removable, from computing device 1100 that is configured to output commands and data to an external device.

Display component 1110 may refer to, e.g., a solid state display that may have touch input capabilities. That is, display component 1110 may include capabilities that may be shared with or replace those of input component 1106.

Computer-readable medium 1112 may refer to a separable machine readable medium that is configured to store one or more programs that embody any of the functions or operations described above. That is, computer-readable medium 1112, which may be received into or otherwise connected to a drive component of computing device 1100, may store executable instructions to implement any of the functions or operations described above. These instructions may be complimentary or otherwise independent of those stored by memory 1104.

Transceiver 1114 may refer to a network communication link for computing device 1100, configured as a wired network or direct-wired connection. Alternatively, transceiver 1114 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A server, comprising:
a data receiving unit configured to receive metadata regarding television content;
a data mapping unit configured to generate mapping information to associate web content with the television content based at least in part on the metadata; and
an information transmitting unit configured to transmit the mapping information to an end device.

2. The server of claim 1, further comprising:
a request receiving unit configured to receive, from the end device, a request for the web content.

3. The server of claim 2, wherein the data receiving unit is further configured to transmit, to a television platform server, a request for the metadata, when the request receiving unit receives the request for the web content from the end device, and
wherein the data receiving unit is further configured to receive the metadata from the television platform server.

4. The server of claim 3, wherein the data receiving unit is further configured to receive the metadata from the television platform server upon calling an application programming interface (API) function.

5. The server of claim 1, wherein the received metadata includes a plurality of sub metadata regarding the television content, and
wherein the data mapping unit is further configured to select at least some of the sub metadata, which is associated with the web content, from among the plurality of sub metadata.

6. The server of claim 5, wherein the data receiving unit is further configured to receive the metadata generated by the television platform server from a file transfer protocol (FTP) server.

7. The server of claim 1, further comprising:
a content transmitting unit configured to transmit the web content to the end device.

8. The server of claim 7, wherein the request receiving unit is further configured to receive, from the end device, a request for television content information that is associated with the web content transmitted to the end device, and
wherein the information transmitting unit is further configured to transmit the mapping information to the end device, in response to the request for the television content information.

9. The server of claim 8, wherein the content transmitting unit is further configured to provide the end device with a television content selecting interface that is to be displayed on the end device.

10. The server of claim 1, wherein the web content includes a partial video of the television content.

11. The server of claim 1, wherein an image resolution of the web content is lower than an image resolution of the television content.

12. An end device, comprising:
a web content receiving unit configured to receive web content from a web content provider;
a data receiving unit configured to receive mapping information to associate the web content with television content;
a web content displaying unit configured to display the received web content and a television content selecting interface that is generated based at least in part on the mapping information;
a television content selecting unit configured to receive a selection input from the television content selecting interface; and
a television content receiving unit configured to:
transmit a request for the television content to a television platform server based at least in part on the selection input,
receive the requested television content from the television platform server, and
display the received television content.

13. The end device of claim 12, wherein the television content receiving unit is further configured to transmit a request for television content information that is associated with the received web content to the web content provider, and
wherein the data receiving unit is further configured to receive the mapping information from the web content provider.

14. The end device of claim 12, wherein the web content includes a partial video of the television content.

15. The end device of claim 12, wherein an image resolution of the web content is lower than an image resolution of the television content.

16. A method performed under control of a server, comprising:
transmitting web content to an end device;
receiving, from a television platform server, metadata regarding television content;
generating mapping information that associates the web content with the television content based at least in part on the metadata; and
transmitting the mapping information to the end device.

17. The method of claim 16, further comprising:
sending, to the television platform server, web content information regarding the web content transmitted to the end device,
wherein the received metadata is associated with the web content information.

18. The method of claim 17, wherein the receiving of the metadata is performed upon calling an application programming interface (API) function.

19. The method of claim 16, wherein the received metadata includes a plurality of sub metadata that are associated with the television content, and
wherein the mapping information is generated by selecting at least some of the sub metadata from among the plurality of sub metadata and associating the television content with the web content based at least in part on the selected sub metadata.

20. The method of claim 16, further comprising:
receiving, from the end device, a request for television content information that is associated with the web content transmitted to the end device,
wherein the transmitting of the mapping information is performed in response to the request for the television content information.
